(19) United States
(12) Patent Application Publication
(10) Pub. No.: US 2008/0035795 A1
(43) Pub. Date: Feb. 14, 2008

(54) Illuminated flying kite

(76) Inventors: Donald W. Hassett, Pearl River, NY (US); Allison Hassett, Pearl River, NY (US)

Correspondence Address: Galasso & Associates, LP, P.O.Box 26503, Austin, TX, 78755-0503, US

(21) Appl. No.: 11/501,532

(22) Filed: Aug. 8, 2006

(51) Int. Cl. B64C 31/06

(52) U.S. Cl. 244/153 R

(57) ABSTRACT

A flying kite designed to be visible when flown in low light conditions. The flying kite includes a body that is generally triangular in shape and configured in a substantially planar manner. The flying kite also comprises a frame that provides structural support for the body. The frame includes three corner frame members and three longitudinal frame members that are interposed the corner frame members. The longitudinal frame members further include two compartments having disposed therein the chemicals necessary to create chemical luminescence subsequent to distressing the frame members. The flying kite further includes two pockets for receiving therein a conventional glowstick.

### FIELD OF THE INVENTION

The present invention relates to a flying device, more specifically to a flying kite that is designed to be visible in low light conditions by utilizing chemical luminescence.

### BACKGROUND

In the history of flight, the exact date and origin of the kite is not know but it is believed that kites were first flown in China more than two thousand years ago. The earliest written account of kite flying is about 200 B.C. when the Chinese General Han Hsin of the Han dynasty flew a kite over the walls of a city he was attacking to measure how far his army would have to tunnel to reach past the defenses. Kite flying was eventually spread by traders from China to Korea, and across Asia to India. Each area adopting a distinctive style of kite and cultural purpose for flying them.

Men like Benjamin Franklin and Alexander Wilson used their knowledge of kite flying to learn more about the wind and the weather. Many early aviators such as the Wright Brothers experimented with kites which contributed to the development of the airplane. The US Weather service flew kites designed by William Eddy and Lawrence Hargraves to raise meteorological instruments and cameras. Kites were even used in the 19^{th} century to pull a carriage at speeds of twenty miles per hour. Kites were used as recently as World War II to prevent airplanes from flying to low over targets. Diamond shaped kites were even used for target practice and aircraft recognition at sea during World War II.

Modern times have seen the kite relegated from military and scientific purposes to solely recreational flying. Recreational kite flying is enjoyed by millions of individuals around the world.

One problem with kite flying is that it is restricted to visible light hours. Individuals who wish to engage in the recreational sport of kite flying must do so when there is enough visible light to see the kite. Flying a kite in low light conditions or at night is virtually impossible.

Accordingly, there is a need for a flying kite that has the ability to be flown in low light or night time conditions and retain the ability to be easily seen by the operator.

### SUMMARY OF THE INVENTION

It is the object of the present invention to provide a flying kite that has the ability to be visible to its operator in low light or night time conditions.

A further object of the present invention is to provide a flying kite that has the ability to be visible to its operator in low light conditions that utilizes chemical luminescence as a method of illuminating the flying kite.

It is another object of the present invention to provide a flying kite that has the ability to be visible to its operator in low light conditions that utilizes chemical luminescence as a method of illuminating that is easy to fly.

Yet another object of the present invention is to provide a flying kite that has the ability to be visible to its operator in low light conditions that utilizes chemical luminescence as a method of illuminating that is relatively inexpensive.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a to view of an embodiment of the present invention;

FIG. 2 is a perspective view of a section of the frame and its luminescent device of an embodiment of the present invention; and

FIG. 3 is a perspective view of a section of the frame of an embodiment of the present invention and its insertable luminescent device.

### DETAILED DESCRIPTION

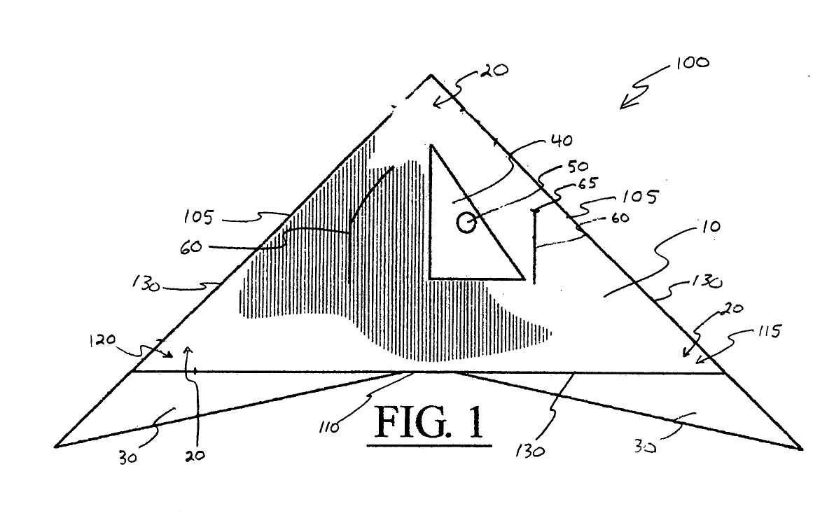

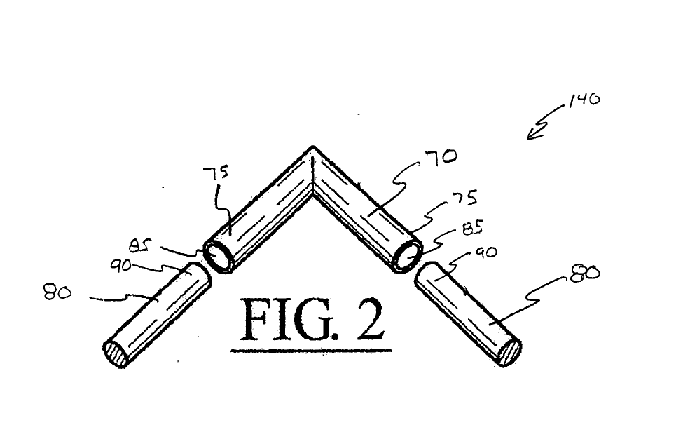

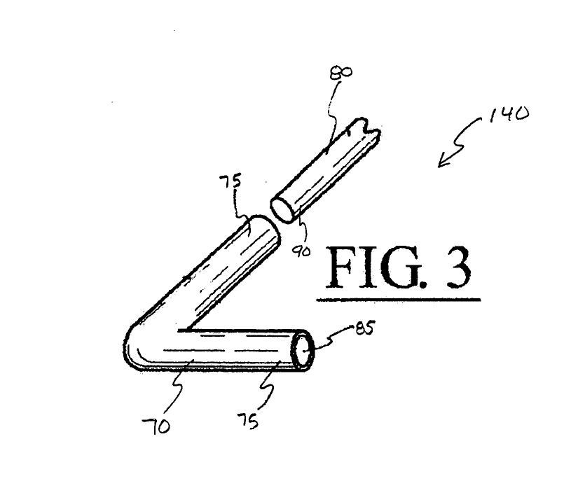

Referring now to the embodiments in FIG. 1 through 3, and wherein the various elements depicted therein are not necessarily drawn to scale and wherein like elements are identified with like reference numerals, there is illustrated the components of a preferred embodiment of a flying kite 100 constructed according to the principles of the present invention.

The flying kite 100 is comprised of a body 10 that is configured in a substantially planar manner. The body 10 is manufactured from a durable lightweight material such as but not limited to cloth or plastic. It is further contemplated within the scope of the present invention that the body 10 be manufactured from a transparent or translucent material. As shown in FIG. 1 submitted herewith, the body 10 is generally triangular in shape. Those skilled in the art will recognize that the body 10 could be numerous different shapes in addition to and/or in conjunction with the shape as shown in the embodiment in FIG. 1. More specifically but not by way of limitation, the body 10 could be diamond shaped. The body 10 functions as the sail for the flying kite 100 providing the needed shape to create lift thus allowing the flying kite 100 to become airborne under the correct conditions of wind speed. Although no particular size of the body 10 is required, good results have been achieved with a lateral edge 105 that is approximately two to three feet in length. Furthermore, good results have been achieved with a bottom peripheral edge 110 intermediate the corners 115, 120 having a length of four to five feet.

Contiguously mounted to the body 10 on opposing corners 115, 120 are the keel members 30 which are manufactured from the same material as the body 10 described herein. The keel members 30 function to control the side to side flight attitude of the flying kite 100 when the flying kite 100 is airborne. Although the keel members 30 are shown in the drawing submitted herewith as being generally angular in shape, those skilled in the art will recognize that numerous different shapes of keel members 30 could be utilized on the body 10 to achieve the function as described herein.

A towing connection 40 is integrally mounted to the body 10. The towing connection 40 is centrally mounted to the body 10 by conventional mechanical or chemical methods such as but not limited to heat welding. The towing connection 40 is manufactured from durable flexible material such as but not limited to plastic. Those skilled in the art will recognize that numerous different materials could be utilized to manufacture the towing connection 40. The towing connection 40 further includes an eyelet 50. The eyelet 50 is an aperture that is generally annular in shape. The eyelet 50 is of sufficient diameter to have journaled therethrough a commonly used towline such as but not limited to string.

Adjacent to the towing connection 40 and mounted on each side thereof are pockets 60. The pockets 60 are disposed within the body 10 and are generally parallel with the towing connection 40. The pockets 60 are generally rectangular in shape and have an opening 65 and are substantially hollow and configured to receive therein an illuminating device such as a conventional glowstick. Although in the drawings submitted herewith two pockets 60 are illustrated, those skilled in the art should recognize that numerous different amounts of pockets 60 could be disposed within the body 10. Furthermore, those skilled in the art should recognize that the pockets 60 could be disposed within the body 10 in a plurality of locations.

Superposed to each corner 20 are the corner frame members 70. The corner frame members 70 are secured to the corners 20 by suitable mechanical or chemical methods such as but not limited to friction, gluing or heat welding. The corner frame members 70 are generally angular in shape and are manufactured from suitable durable and lightweight material such as plastic tubing. While in the drawings submitted herewith the corner frame members 70 are shown as being substantially tubular in shape, it is further contemplated within the scope of the present invention that the corner frame members 70 could be manufactured from rectangular tubing. Those skilled in the art will recognize that the corner frame members 70 could be numerous different shapes in order to correspond with different shapes of corners 20.

The corner frame members 70 have two ends 75 with apertures 85. The apertures 85 are of sufficient diameter to receive therein one end 90 of the frame members 80. The corner frame members 70 are substantially hollow and configured to receive therein the frame members 80. The corner frame members 70 are releasably secured to the frame members 80 to comprise the frame 140. The frame 140 provides structural support for the flying kite 100.

Intermediate each corner frame member 70 and generally parallel with the peripheral edges 130 of the body 10 are the frame members 80. The frame members 80 are generally cylindrical in shape and are substantially disposed along the peripheral edges 130 functioning to connect the corner frame members 70 to form a frame 140. The frame members 80 are manufactured from a translucent plastic tube having two internal compartments that contain chemicals that are used to create light or chemical luminescence.

As is known to those skilled in the art, a chemical luminescence device is typically a plastic cylindrical rod that contains two chemical fluids in two different compartments. One compartment contains one chemical fluid and the other compartment contains another chemical fluid. The compartments are brittle and are generally manufactured from glass or brittle plastic. A user will distress the frame member 80 before inserting into the apertures 85 of opposing corner frame members 70. Subsequent to distressing the frame member 80, the internal compartments of the frame member 80 rupture thereby allowing the two chemicals substantially disposed within each compartment to combine. This causes a chemical reaction that result in the emission of light but not necessarily heat.

The chemicals contained within the internal compartments of the frame member 80 are hydrogen peroxide and phenyl oxalate ester. Further, the compartment containing the phenyl oxalate ester contains an additional fluorescent dye that is used to produce a color when the two chemicals combine. The combination of phenyl oxalate ester and hydrogen peroxide cause the ester to oxidize giving out two molecules of phenol and one molecule of peroxyacid. The peroxyacid decomposes spontaneously to carbon dioxide, releasing energy that excites a fluorescent dye that then de-excites by releasing a photon. The wavelength of the photon depends on the structure of the dye. Different dyes results in different colors. Those skilled in the art will recognize that numerous different types of fluorescent dye could be utilized within the frame member 80 to produce a variety of different colors. More specifically but not by way of limitation, 9,10-bis(phenylethynyl) anthracene can be used to produce a green light and 9,10-diphenylanthracene to produce a blue light. It is further contemplated within the scope of the present invention that the frame member 80 could have disposed therein within two internal compartments other chemicals that could be utilized to create chemical luminescence. More specifically but not by way of limitation, sodium salicylate, bis(2-ethylhexyl)phthalate, bis(phenyl) oxalate and bis(2,4,5-trichlorophenol-6-carbopentoxyphenyl)oxalate.

It is also contemplated within the scope of the present invention that the frame member 80 could have disposed therein other conventional light emitting devices. More specifically but not by way of limitation, a conventional LED light could be substantially disposed within the frame member 80 along with a small power supply to provide power to the lights. Although it is not illustrated in the drawings submitted herewith, it is further contemplated within the scope of the present invention, that the frame member 80 could be comprised of a conventional plastic tube having access thereon that would allow a user to place within the hollow frame member 80 a light emitting device such as a conventional glowstick.

Referring now in particular to FIG. 1, a description of the operation of the flying kite 100 is as follows. In use, a user will place the body 10 of the flying kite 100 on a suitable horizontal support structure with the corner frame members 70 facing in a generally upward direction. The user will then distress the tubular frame members 80 and insert each end 90 into an aperture 85 of the corner frame members 70 on opposing corners 20. When the frame member 80 is distressed it causes the two compartments disposed therein to rupture thus creating the chemical luminescence as described herein. The user continues to complete the frame 140 by inserting the frame members 80 into opposing corner frame members 70 until all of the corner frame members 70 have disposed therebetween a frame member 80. The user then secures an appropriate line or string to the towing connection 40 utilizing the eyelet 50. If desired, the user can insert additional chemical luminescent devices substantially in the pocket 60 in the body 10 for added visual effect. The user then flies the flying kite 100 as is known in the art.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A manually operated flying device comprising:
a body being configured to provide lift for said flying device;
a frame, said frame being superposed to one side of said body, said frame having at least one corner frame member, said frame further including at least one frame member being configured to connect to said corner frame member, said frame being generally tubular in shape, said frame for providing support for said body; and
a first light emitting device removably disposed within said frame.

2. The manually operated flying device as recited in claim 1, wherein said body further includes at least one pocket, said pocket configured to receive therein a second light emitting device.

3. The manually operated flying device as recited in claim 2, wherein said first light emitting device produces light by chemical luminescence.

4. The manually operated flying device as recited in claim 3, wherein said body further includes an towing connection, said towing connection being integrally mounted to said body, said towing connection for providing a method of engaging the flying device with a tow line.

5. The manually operated flying device as recited in claim 4, wherein said body further includes at least one keel member, said keel member being generally angular in shape, said keel member being contiguously mounted to said body, said keel member for controlling the attitude of said flying device.

6. The manually operated flying device as recited in claim 5, wherein said first light emitting device includes two chemicals from a group consisting of sodium salicylate, bis (2-ethylhexyl)phthalate, bis(phenyl)oxalate, bis(2,4,5-trichlorophenol-6-carbopentoxyphenyl)oxalate, hydrogen peroxide and phenyl oxalate ester.

7. The manually operated flying device as recited in claim 6, wherein said first light emitting device includes a fluorescent dye from a group consisting of 9,10-bis(phenylethynyl) or 9,10-diphenylanthracene.

8. A kite comprising:
a body configured to provide lift, said body manufactured from a lightweight material;
a frame connected to said body with at least a portion of said frame being translucent, said frame including at least three corner frame members and at least three longitudinal frame members connected between said at least three corner frame members; and
a first light emitting device disposed within said frame proximate said translucent portion.

9. The kite as recited in claim 8, wherein said body further includes at least one pocket, said pocket configured to receive therein a second light emitting device.

10. The kite as recited in claim 9, wherein said first light emitting device produces light by chemical luminescence.

11. The kite as recited in claim 10, wherein said body further includes a towing connection, said towing connection being integrally mounted to said body, said towing connection for providing a connection with a tow line.

12. The kite as recited in claim 11, wherein said body further includes at least one keel member, said keel member being generally angular in shape, said keel member being contiguously mounted to said body, said keel member for controlling the attitude of said kite.

13. The kite as recited in claim 12, wherein at least one of said longitudinal frame members include an internal compartment for receiving said first light emitting device.

14. The flying kite as recited in claim 13, wherein said first light emitting device includes two chemicals from a group consisting of sodium salicylate, bis(2-ethylhexyl)phthalate, bis(phenyl)oxalate, bis(2,4,5-trichlorophenol-6-carbopentoxyphenyl)oxalate, hydrogen peroxide and phenyl oxalate ester.

15. A toy flying kite comprising:
a body, said body having at least three corners, said body being manufactured from a lightweight material, said body further including a first and second keel member, said first and second keel member being generally angular in shape, said first and second keel members being contiguously mounted to said body, said first and second keel members for controlling the attitude of said flying device, said body being configured to provide lift for said flying device;
a frame, said frame further including three corner frame members, said corner frame members being configured in shape to correspond with the shape of the three corners of said body, said corner frame members superposed to one side of said body, said corner frame members having a first end and a second end, said corner frame members having an aperture proximate said first end and said second end of said corner frame members for receiving therein a longitudinal frame member, said corner frame members being integrally mounted to said body, said corner frame members for providing structural support for said body, said frame further including three longitudinal frame members, said longitudinal frame member being cylindrical in shape and having two internal compartments substantially disposed therein, said internal compartments being configured to retain chemical luminescent materials, said longitudinal frame members having a first end and a second end, said longitudinal frame members being intermediate said corner frame members and superposed said body, said longitudinal frame members for providing support for said body;
a towing connection, said towing connection being contiguously mounted to said body, said towing connection further including an eyelet, said towing connection for providing an interface for said toy flying kite and a towline.

16. The toy flying kite as recited in claim 15 wherein said body further includes two pockets, said pockets being configured in a substantially parallel manner, said pockets being configured to receive therein a conventional glowstick.

17. The toy flying kite as recited in claim 16, wherein said internal compartments of said longitudinal frame members contain therein a group of chemicals consisting of sodium salicylate, bis(2-ethylhexyl)phthalate, bis(phenyl)oxalate, bis(2,4,5-trichlorophenol-6-carbopentoxyphenyl)oxalate, hydrogen peroxide and phenyl oxalate ester.

18. The toy flying kite as recited in claim 17, wherein one of said two internal compartments of said longitudinal frame members further include a fluorescent dye from a group consisting of 9,10-bis(phenylethynyl) or 9,10-diphenylanthracene.

19. The toy flying kite as recited in claim 18, wherein said body has two sides that are approximately two to three feet in length and one side that is approximately four to five feet in length.

20. The toy flying kite as recited in claim 19, wherein said body is manufactured from plastic.
